(19) United States
(12) Patent Application Publication
(10) Pub. No.: US 2007/0158542 A1
(43) Pub. Date: Jul. 12, 2007

(54) Mass spectrometry

(75) Inventors: Ute Bauer, Frankfurt am Main (DE); Alfonso Moraga-Martinez, Frankfurt am Main (DE); Josef Schwarz, Frankfurt (DE)

Correspondence Address: BUCHANAN, INGERSOLL & ROONEY PC, POST OFFICE BOX 1404, ALEXANDRIA, VA, 22313-1404, US

(73) Assignee: Electrophoretics Limited, Cobham Surrey (GB)

(21) Appl. No.: 10/556,915

(22) PCT Filed: May 13, 2004
(86) PCT No.: PCT/GB04/02059

§ 371 Date: Apr. 12, 2006

(30) Foreign Application Priority Data
May 15, 2003 (GB) 0311225.7
May 27, 2003 (GB) 0312095.3

(51) Int. Cl. B01D 59/44

(52) U.S. Cl. 250/282

(57) ABSTRACT

Provided is a method for processing data from a mass spectrum generated from a sample, which method comprises: (a) selecting a first peak in the mass spectrum; (b) selecting a first monoisotopic reference ion having a first charge state, which first reference ion could contribute to the first peak; (c) for one or more other isotopic forms of the first reference ion determining one or more further expected peaks in the mass spectrum; (d) comparing one or more of the determined further expected peaks with the mass spectrum to determine whether there are one or more peaks present in the spectrum that match the one or more determined further expected peaks; (e) if one or more of the determined further expected peaks match one or more of the peaks in the mass spectrum, designating the first peak as a data peak, and optionally designating the one or more peaks present in the spectrum that match the one or more determined further expected peaks as data peaks; (f) if the determined further expected peaks do not match peaks in the mass spectrum, repeating steps (b) to (e) with one or more further reference ions in one or more further charge states; (g) optionally if the first peak cannot be designated as a data peak for a reference ion in the first charge state, or for a further reference ion in the further charge states, designating the first peak as a non-data peak; (h) optionally repeating steps (a)-(g) for one or more further peaks in the mass spectrum.

This invention relates to useful methods for deconvoluting or simplifying mass spectra, to aid in their interpretation. More specifically the invention relates to methods for the identification of peaks in a spectrum which result from ions from a sample under investigation, and peaks which result from background radiation, noise or other non-data sources. In particular the method identifies peaks having specific distributions of isotopic variants. The invention is thus capable of rapidly identifying ions with characteristic isotope distributions by comparison with pre-determined isotope distribution templates. These methods are of particular value for the analysis of data obtained by time-of-flight mass analysers.

Mass spectrometry is emerging as the favoured tool for the analysis of large biomolecules, particularly for the analysis of peptides and proteins. Mann and co-workers, for example, have shown that the mass of a single peptide along with partial sequence information, which can be determined through collision induced dissociation of the peptide, can be sufficient to identify the parent protein (¹). Consequently, new methods are being developed in which specific peptides are isolated from each protein in a mixture. Conceptually, the simplest approach to the analysis of complex polypeptide mixtures is seen in the MudPIT procedure in which a mixture of polypeptides is digested with a protease and all digest peptides are analysed by Liquid Chromatography Mass Spectrometry (LC-MS) (²; ³). The MudPIT approach overcomes the problem of the complexity of the sample by attempting to separate all of these peptides with high resolution multi-dimensional chromatography, but it is not uncommon for many peptides to elute form the chromatographic column simultaneously. Liquid Chromatography separations are generally interfaced to Mass Spectrometry by an electrospray ionisation source. Electrospray ionisation is a very ‘gentle’ technique for getting ions in the liquid phase into the gas phase but ionisation of large biomolecules tends to result in ions being present in multiple charge states complicating the resulting mass spectra⁴. Thus the mass spectra that result from the combination of MudPIT and electrospray mass spectrometry are very complex.

‘Sampling’ methods are starting to come to the fore as a way of reconciling the need to deal with small populations of peptides to reduce the complexity of the mass spectra generated while retaining sufficient information about the original sample to identify its components. The ICAT procedure (⁵) uses ‘isotope encoded affinity tags’, a pair biotin linker isotopes, which are reactive to thiols, for the capture peptides with cysteine in them. In the ICAT procedure a sample of protein from one source is reacted with a ‘light’ isotope biotin linker while a sample of protein from a second source is reacted with a ‘heavy’ isotope biotin linker. The two samples are then pooled and cleaved with an endopeptidase. The biotinylated cysteine-containing peptides can then be isolated on avidinated beads for subsequent analysis by mass spectrometry. The two samples can be compared quantitatively: corresponding peptide pairs act as reciprocal standards allowing their ratios to be quantified. The ICAT sampling procedure produces a mixture of peptides that represents the source sample that is less complex than MudPIT, but large numbers of peptides are still isolated and their analysis by LC-MS/MS generates complex spectra.

Peptide mass fingerprinting, using Matrix Assisted Laser Desorption Ionisation Time-of-Flight (MALDI TOF)⁶⁻⁸ is a further mass spectrometric technique that has been widely used in the analysis of 2-D gel separated proteins (⁹; ¹⁰; ¹¹) and is a robust method for protein identification. MALDI TOF is a very gentle ionisation procedure that generates relatively simple mass spectra as large biomolecules tend to ionise giving only the +1 state¹². Some useful techniques for obtaining more information about peptides have been developed for MALDI based on labelling peptides with tags that impart a characteristic isotope distribution to the peptide¹³. This allows labelled peptides to be identified by their characteristic isotope signatures. However, there is a need for automated software for the interpretation of such spectra as it is a slow task to perform manually.

Consequently, there is a need for software to rapidly deconvolute these complex spectra, particularly those generated by electrospray ionisation of peptide mixtures, and to identify specific ion classes in the spectra. Peptides have characteristic isotope distributions due to their relatively predictable carbon, nitrogen, oxygen and hydrogen distributions. Some elements are typically not present in peptides, such as halogen atoms while others, such as sulphur and phosphorus are occasionally present. These different atomic compositions give rise to characteristic isotope compositions for peptides due to the natural variations in the abundances of the isotopes of the elements that typically comprise a peptide. Such distributions can in principle be detected in mass spectral data but effective software for this purpose is not available. Similarly, altered distributions can be created by labelling peptides. There is however no software available for the automatic processing of spectra to identify ions with characteristic isotope abundance distributions in complex spectra.

It is an aim of this invention to solve the problems associated with the above prior art. In particular, it is an aim of the present invention to provide a method for distinguishing between peaks in a mass spectrum that result from a sample under investigation, and peaks that do not, in order to deconvolute and/or simplify the spectrum. In particular, it is an aim of this invention to provide methods of identifying ions with characteristic isotope distributions in mass spectra, even if the ions may have widely different masses and may exist in multiple charge states.

It is a further object of this invention to provide automated methods of interpreting spectra to identify and quantify ions present in the spectra.

Accordingly, the present invention provides a method for processing data from a mass spectrum generated from a sample, which method comprises:
(a) selecting a first peak in the mass spectrum;
(b) selecting a first monoisotopic reference ion having a first charge state, which first reference ion could give rise to the first peak;
(c) for one or more other isotopic forms of the first reference ion determining one or more further expected peaks in the mass spectrum;
(d) comparing one or more of the determined further expected peaks with the mass spectrum to determine whether there are one or more peaks present in the spectrum that match the one or more determined further expected peaks;
(e) if one or more of the determined further expected peaks match one or more of the peaks in the mass spectrum, designating the first peak as a data peak, and optionally designating the one or more peaks present in the spectrum that match the one or more determined further expected peaks as data peaks;
(f) if the determined further expected peaks do not match peaks in the mass spectrum, repeating steps (b) to (e) with one or more further reference ions in one or more further charge states;
(g) optionally if the first peak cannot be designated as a data peak for a reference ion in the first charge state, or for a further reference ion in the further charge states, designating the first peak as a non-data peak;
(h) optionally repeating steps (a)-(g) for one or more further peaks in the mass spectrum.

In step (a), a first peak from the mass spectrum is selected or identified for investigation. Any peak in the spectrum may be selected initially when carrying out the method. However, preferably the peak corresponding to the lowest mass and/or highest charge state in the spectrum is selected, since generally such peaks are often the most accurately resolved by the spectrometer. It is preferred that all mass/charge ratios are related to the highest m/z in order to maintain the highest accuracy. If necessary, the spectral data may be pre-processed to aid in identifying peaks in the spectrum, such as by smoothing.

After the preliminary analysis described above a model may be fitted to the designated data peaks if desired. The peaks will have a certain breadth and height, giving them a characteristic shape. This shape depends on a number of factors, including the nature of the spectrometer being employed. Thus, identical ions will not all be recorded with exactly the same m/z value. In a time of flight analyser, some will arrive slightly ahead or behind others. It is this that gives the peaks their characteristic shape. This shape may be modelled using any appropriate function, but Gaussian, Lorenzian and Voigt functions are preferred, as explained below. From this modelling, a more accurate peak shape can be determined, which in turn allows a more accurate m/z value to be determined for each peak. This greatly aids in the subsequent peak analysis and spectrum assignment described below.

The reference ion selected may be any ion with a particular mass and charge state that in theory could be responsible for the first peak. The reference ion can be selected from a database of such ions, or can be calculated at the time of processing. At this stage it is preferred that the ion selected has each of its constituent atoms present in their most common isotope, since this ion will naturally be the most abundant out of the possible isotopes, and will therefore provide the greatest contribution to the spectrum. Such ions are termed monoisotopic ions in the context of this invention. In some cases, more than one monoisotopic ion will exist that could be responsible for the first peak, some in the same charge state and others in different charge states. In this invention, it is preferred that monoisotopic ions in the same charge state (usually the highest charge state) are considered first, and other charge states are investigated separately during one or more further iterations of the method.

After the first ion is selected in its monoisotopic form, an isotope distribution for that ion may be determined. The different isotopes of each of its constituent atoms are present in nature in different abundances, and these abundances will effect the quantity of all of the possible ions having the same chemical structure, but different isotopes, that will be present. The less common the isotopes present in an individual ion, the less of that ion will be present compared to the corresponding monoisotopic ion. Each ion having the same chemical structure, but different isotopic distribution, is, in the context of this invention, said to be in the same ion family.

Due to the different masses of the isotopes constituting an ion family, an ion family will produce a variety of peaks in a mass spectrum, clustered around the strongest (most intense) peak, which should normally correspond to the monoisotopic member of the family. Due to the variance in their abundance, the other peaks should have intensities relative to their abundances, which can be calculated, since the natural isotopic abundances are well known. These are the determined further expected peaks in the spectrum. They may be determined by comparison with pre-calculated information in a database, such as in the form of a template of peaks for an ion, or may be determined by calculation in real time if desired. When more than one monoisotopic ion may be responsible for the peak, the relative proportions of each ion thought to be present can be used to create a weighted average of peak strengths for each ion isotope. For example, if there are two monoisotopic ions that could be present (two ion families) it might be assumed that they are present in equal quantity (50:50 ratio), in which case the calculated further expected peaks for each family would be halved in strength, as compared with peaks where only a single ion family is present. For a 60:40 ratio, one family would be 3/5 strength and the other 2/5 strength and so on. These ratios may be estimated based on the source of a sample—some compounds are more likely to be present in a biological sample than others.

As mentioned above, the calculation may be performed in real time, or may have been performed previously. In the case where ions are first selected from a database, a pre-calculated template for an ion family may be employed, which template contains the isotope peaks in their calculated distributions. For more than one ion family the templates may be overlaid in whichever proportions it is believed that the ions are present.

The calculated peaks and/or the templates, are then compared with the spectrum to see if any peaks are present in the spectrum that match them. The isotopic distribution around a ‘real’ peak will be characteristic of real data, whereas a spurious peak resulting from noise, cosmic rays, apparatus artefacts, or other interference will not display such a distribution. Thus ‘data’ peaks can be separated from ‘non-data’ peaks. The matching process may preferably compare the separation between expected peaks and/or the relative intensities of expected peaks, with the peaks in the spectrum, and if a certain threshold is reached a match is recorded. The threshold can be altered depending on how sensitive the user requires the method to be. Other parameters can be used for comparison, if desired, such as the breadth or shape of peaks. Functions for modelling such parameters are well known in the art and are discussed below.

In the context of the present invention, a template matching process referred to below means a process which matches a series of parameters determined from peaks in a spectrum to the expected parameters of peaks from known ion classes, where there are no free parameters in the matching process.

Also in the context of the present invention, a model fitting process means a process which attempts to fit a model derived from known ion classes to a series of peaks from a mass spectrum by estimating a series of free parameters to find a local minimum error between the model and the real data, where the error is determined using a cost function. A cost function is chosen to ensure that the data fits the model as closely as possible.

These mathematical methods are well known in the art and have been discussed extensively in signal processing texts.

The procedure for the first peak may be repeated until it has either been identified as a real data peak, or until no match has been found, in which case the peak may be discarded from consideration when assigning the spectrum. Repetition typically involves selection of a new reference ion in the next charge state until all charge states have been tested. Once this occurs, then the iteration for that first peak is finished. The whole procedure may then be repeated for peaks that have not already been designated as data peaks, e.g. for a second peak, third peak, fourth peak, etc. until all peaks have been tested, or as many have been tested as desired. Preferably the highest common charge state resolvable in the spectrometer being employed is used first, with the lowest mass peak. Since peaks are measured as a mass/charge ratio (mn/z), this involves beginning at lowest m and highest z and iterating with z one unit lower each time until the smallest value of z is reached. Then the next peak in the spectrum is selected and the procedure repeated. Generally, for time of flight (TOF) spectrometers, the highest charge state resolved is +6, although +8 is possible in some instances. Therefore, preferably the method begins with a charge state of +8 and works down to +1. More preferably, the method begins with a charge state of +6 and works down to +1. Alternatively, the negative ion configuration may be employed. In this case one begins with −8 and proceeds to −1, or from −6 to −1.

Once the spectrum has been processed and the data peaks identified, it may be desirable to convert the spectrum to one that is representative of ions that are present in the same charge state, preferably the +1 or −1 state. Accordingly, in some embodiments of the invention, the method comprises a further step of determining whether there are different charge states of the same molecular species present in the spectrum, and reducing the peaks produced from these multiple charge states to peaks that would result from a single charge state. The intensity of the newly formed peaks is the sum of the intensifies of the contributions from the individual charge states for that molecular species. In this way, the number of peaks in the spectrum is greatly reduced, facilitating assignment of the peaks. A similar approach may be taken in respect of peaks from multiple isotopomers of the same ion. These reductions allow direct comparison of quantities of each chemical species present, irrespective of charge or isotope differences that are unimportant from a chemical and biological viewpoint.

Once the data peaks are determined, the final assigning of the spectrum may be carried out in a greatly simplified manner.

The present invention also provides a computer program for processing data from a mass spectrum, which computer program is arranged to perform the steps of:
(a) selecting a first monoisotopic reference ion having a first charge state, which first reference ion could contribute to a first peak in the mass spectrum;
(b) for one or more other isotopic forms of the first reference ion, determining one or more further expected peaks in the mass spectrum;
(c) comparing one or more of the determined further expected peaks with the mass spectrum to determine whether there are one or more peaks present in the spectrum that match the one or more determined further expected peaks;
(d) if one or more of the determined further expected peaks match one or more of the peaks in the mass spectrum, designating the first peak as a data peak, and optionally designating the one or more peaks present in the spectrum that match the one or more determined further expected peaks as data peaks.

Preferably the computer program comprises instructions for causing a data processing means to perform some or all of the above steps.

The present invention also provides a method of interpreting a mass spectrum generated from a sample, which method comprises:
(a) processing data from the mass spectrum according to a method as defined above; and
(b) interpreting the spectrum on the basis of the data peaks only.

The present invention also provides a method for performing a MudPIT procedure, comprising a method of interpreting a mass spectrum as defined above and a method for performing an ICAT procedure, comprising a method of interpreting a mass spectrum as defined above.

The invention will now be discussed in more detail, with reference to the following Figures, in which:

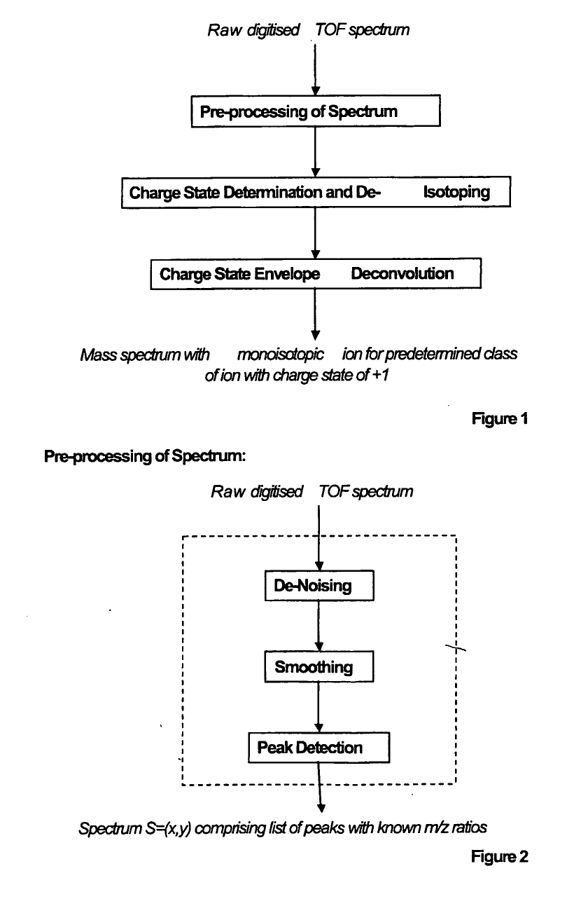

FIG. 1 shows a flow-chart illustrating the general steps used in the analytical method provided by the invention for analysis of mass spectrometry data;

FIG. 2 illustrates a typical series of pre-processing steps used to prepare spectra for analysis by the methods of this invention, involving a spectrum S, made up of peaks having m/z=x and intensity y etc in which the m/z ratios of the peaks are known;

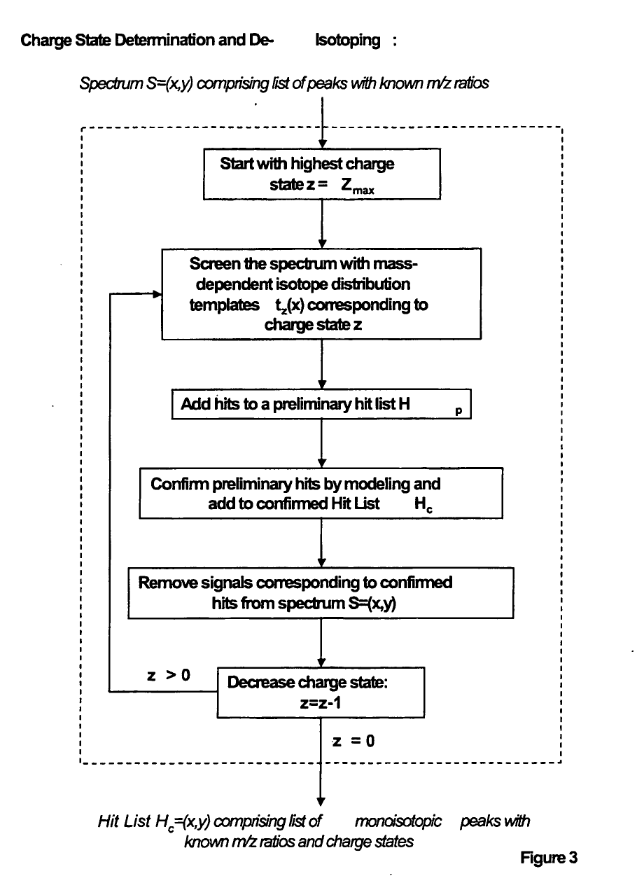

FIG. 3 shows a flow-chart illustrating the general steps used in applying the isotope templates of this invention to a mass spectrum indicating iteration of the method for progressively lower charge states;

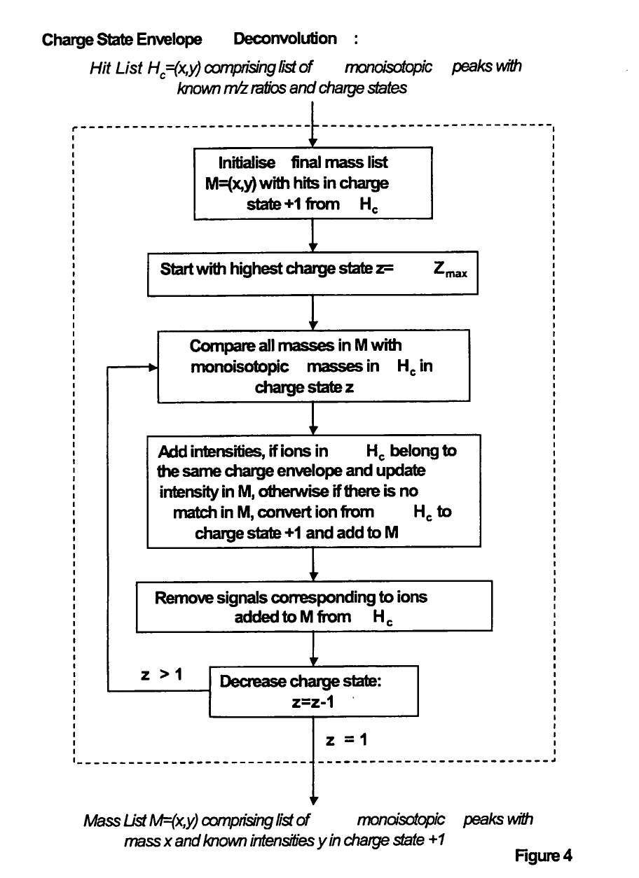

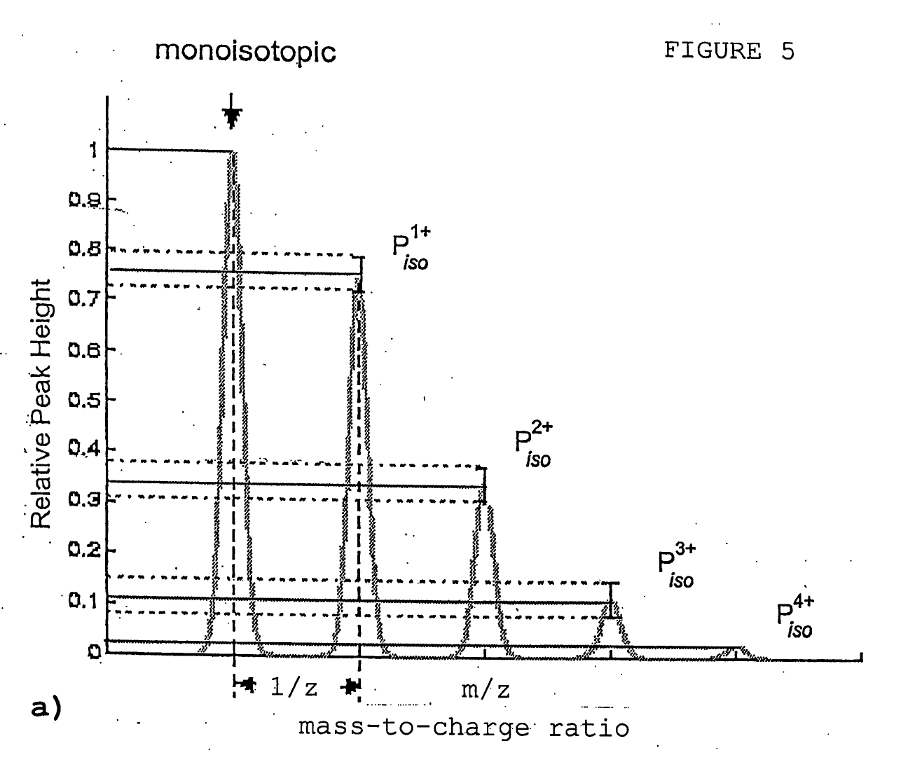

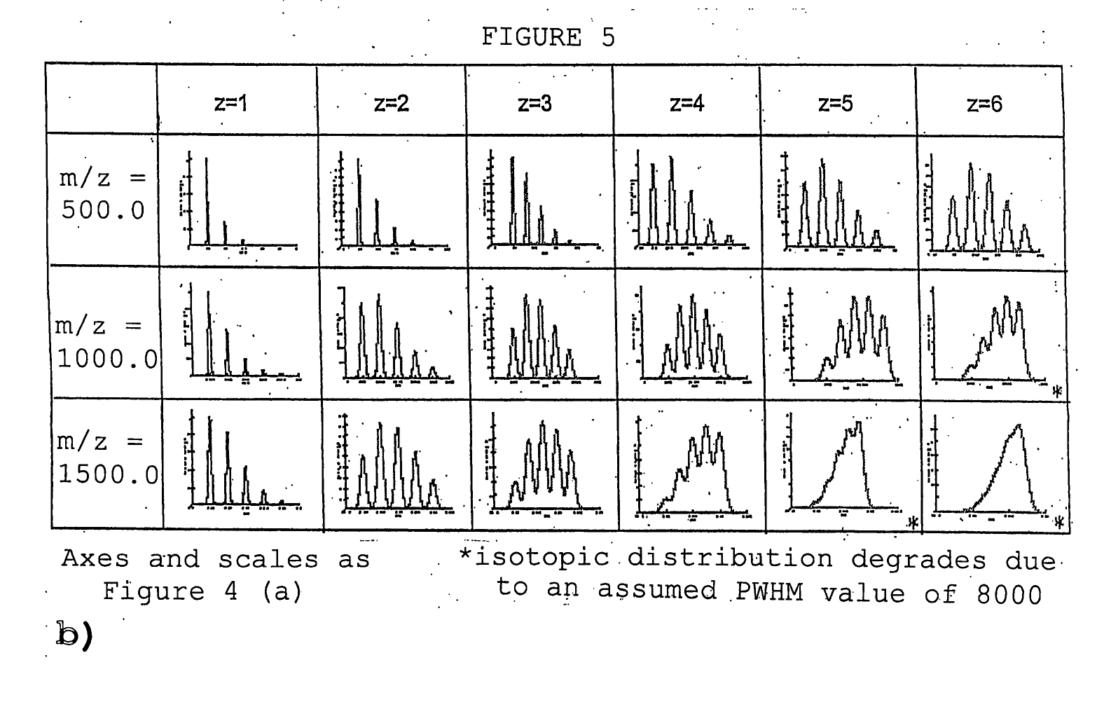

FIG. 4 shows a method of converting the multiple charge state data obtained by the processing method of the present invention, to data which correspond to the spectrum that would have been obtained if all ions had been present in the same charge state (preferably +1)—thus the flow-chart illustrates the general steps used to deconvolute the charge states of a list of ions in a hit list of mono-isotopic ion peaks with known mass-to-charge ratios and known charge states;

FIG. 5a shows a theoretical distribution peptide isotope ratios for a peptide with a moderate mass in the +1 charge state;

FIG. 5b shows some average expected isotope abundance distributions for peptides with three different masses in a number of different charge states derived using a Gaussian model of the ion arrival time in a Time-of-Flight Mass Spectrometer;

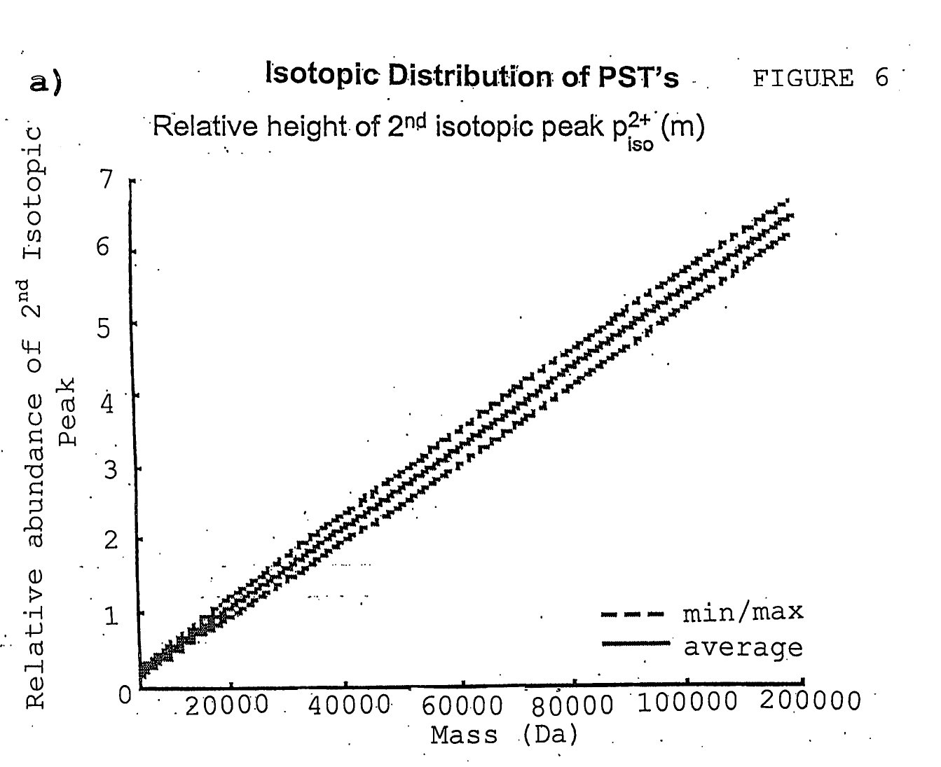

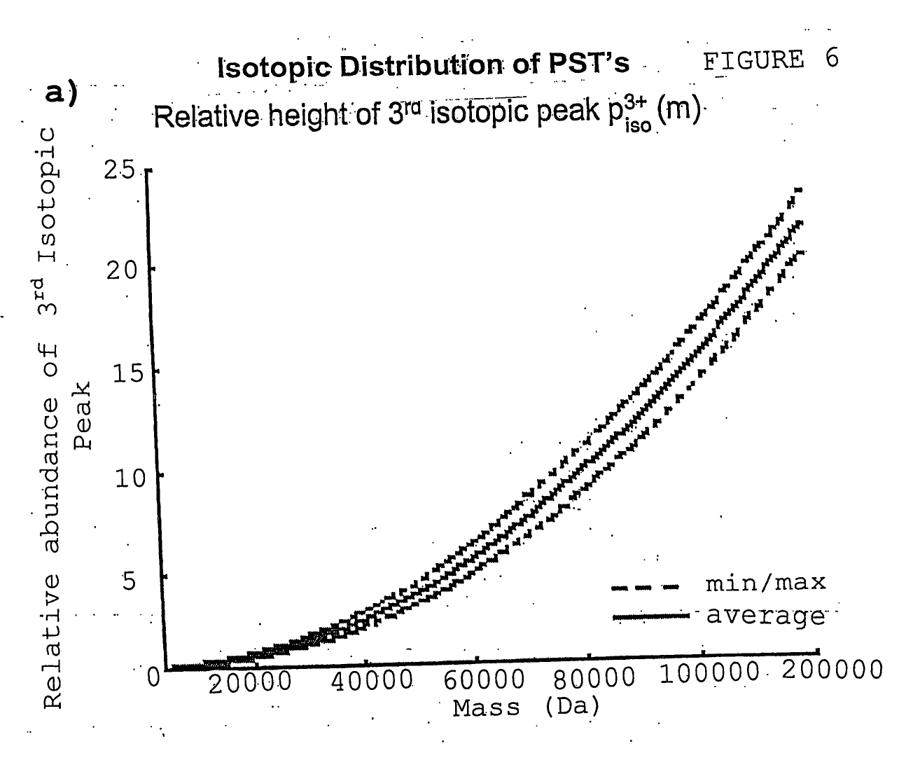

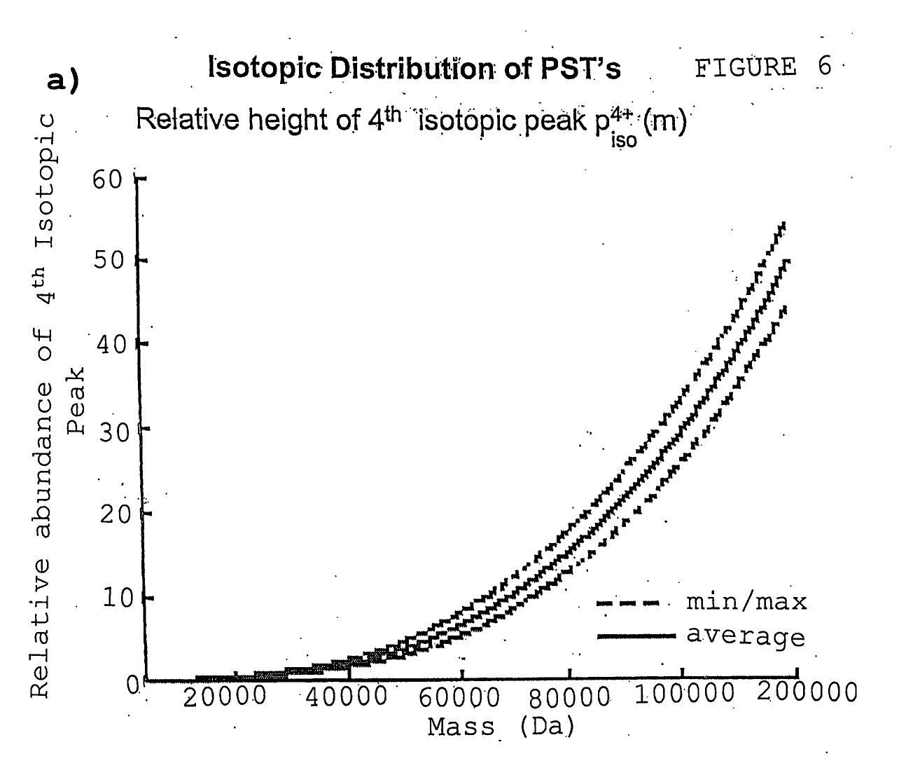

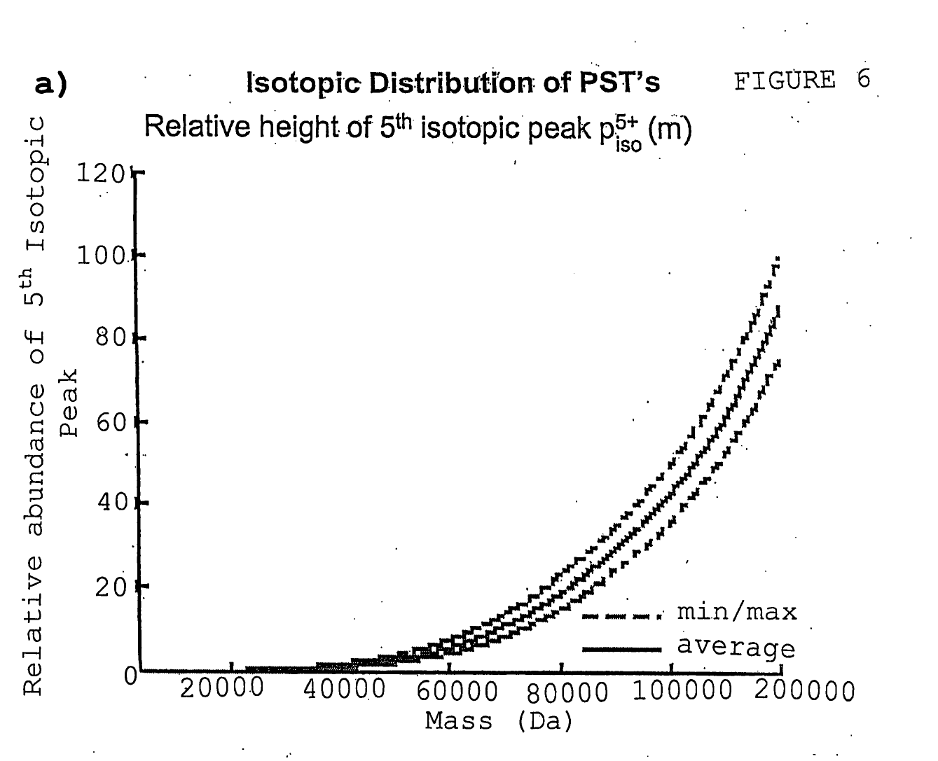

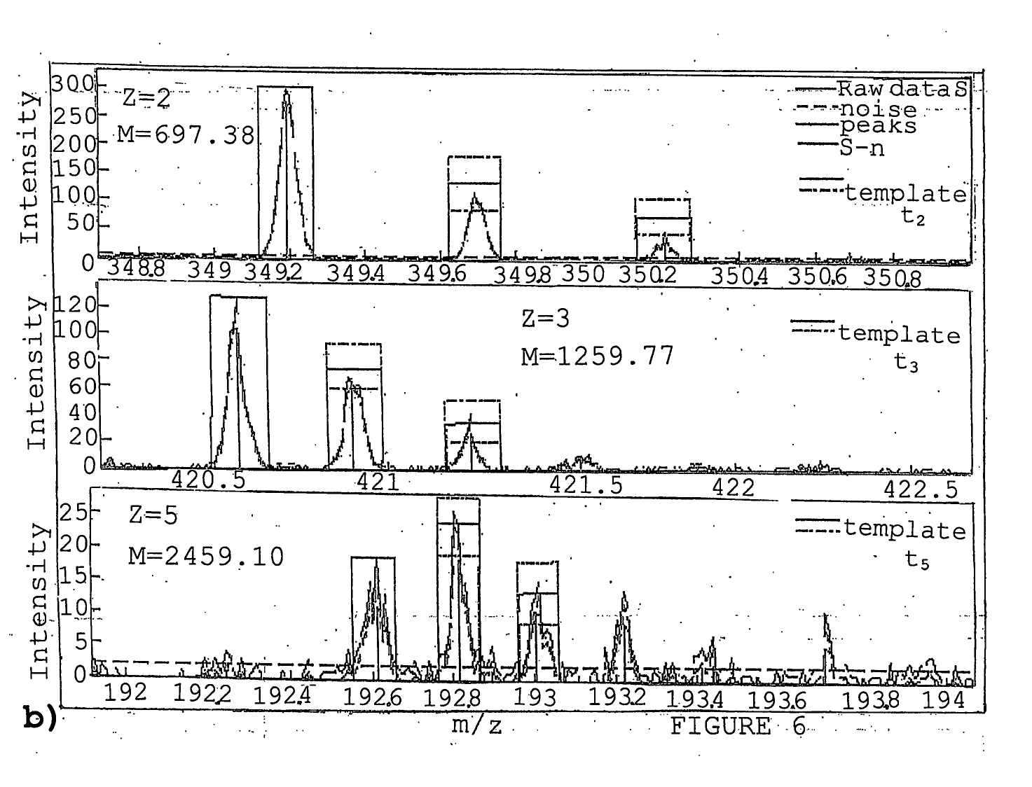

FIG. 6a shows how the ratios of the intensities of different peptide isotope peaks change with the mass of the peptide; and

FIG. 6b illustrates the concept of the fast template fitting process described below.

In a first typical aspect, the invention provides a method of identifying ion families corresponding to molecular species with characteristic isotope abundance distributions in a mass spectrum, where the mass spectrum comprises a list of identified peaks corresponding to ions with known mass-to-charge ratios, and where the method comprises the following steps:
1. calculating for one or more peaks in a spectrum, charge- and mass-dependent isotope abundance distribution templates characteristic of different pre-determined classes of ions for use in the identification of peaks that correspond to ions of those predetermined classes;
2. applying the calculated series of mass- and charge-dependent isotope distribution templates consecutively, starting from the template corresponding to each ion in the spectrum starting with the highest expected charge state to rapidly identify regions of the mass spectrum that match the isotope templates, where the series of templates comprises individual templates for predetermined classes of ions;
3. fitting models of expected isotope distributions to the ions identified by the template matching procedure to confirm the preliminary identifications; and
4. optionally, reducing peaks corresponding to multiple isotopomers of a single ion to a single monoisotopic peak.
5. optionally, determining whether there are different charge states of the same molecular species in the spectrum and reducing these to a single charge state whose intensity is the sum of the intensities of the combined charge states for that molecular species.

In a second typical aspect the invention provides a method of identifying ions with characteristic isotope distributions in time-of-flight mass analyser data comprising the following steps:
1. obtaining data comprising the flight times of one or more ions through the drift region of a time-of- flight mass spectrometer;
2. processing the data comprising flight times through said drift region and the number of ions which have each of a plurality of different transit times to produce at last one observed mass spectrum comprising data representing the number of ions having particular transit times;
3. recognizing in a said observed mass spectrum portions of said data which correspond to mass peaks;
4. using predetermined charge- and mass-dependent isotope distribution templates characteristic of a class of ions to identify ions of the predetermined class;
5. fitting models of expected isotope distributions to the ions identified by the template matching procedure to confirm the preliminary identifications;
6. optionally, reducing peaks corresponding to multiple isotopomers of a single ion to a single monoisotopic peak.
7. optionally, determining whether there are different charge states of the same molecular species in the spectrum and reducing these to a single charge state whose intensity is the sum of the intensities of the combined charge states for that molecular species.

A third typical aspect of this invention provides multiple copies of a computer program for interpretation of mass spectra on computer-readable storage media where each computer readable storage medium is attached to one of a group of processor and where each processor is linked by a communication means to all the other processors in the group. All of the processors in the group are also linked over a network to a master processor. The master processor is also connected to a computer readable storage medium on which there is program for splitting mass spectra into sub-spectra and distributing these to the computers in the cluster. In addition the program on the computer readable storage medium attached to the master processor is capable of re-assembling the interpreted sub-spectra after they have been analysed by the processor in the aforementioned group.

In a fourth typical aspect, this invention provides a method for identifying peptides which comprise specific amino acids in mass spectra, comprising the steps of:
1. reacting a complex mixture of peptides with a tag that will react specifically with one or more reactive functionalities in those peptides, where the tag causes a change in the isotope distribution of that tagged peptide;
2. calculating for one or more ions in a spectrum a series of tag-, charge- and mass- dependent isotope distribution templates where there is a template for each expected combination of charge state, mass range and number of tags present in the peptides;
3. applying the mass- and charge-dependent isotope distribution templates consecutively to the ions in a mass spectrum generated by the analysis of the tagged peptides, starting with the template for the highest expected number of tags, and charge state, to find regions of the mass spectrum that match the isotope templates;
4. optionally fitting models of the expected isotope distributions to the peptide ions identified by the template matching procedure to confirm the preliminary identifications, thereby identifying the charge state of the peptide and the number of tags reacted with the peptide.

According to the first typical aspect of this invention, a list of mass- and charge-dependent templates are calculated. For the purposes of this invention templates are calculated by determining the average distribution of isotope abundances or intensities for a large number of different peptides with different mass and charge states. The isotope abundance distribution of a peptide is determined by the abundances of natural isotopes of the atoms that comprise that peptide and the number of ways the different natural isotopes can be distributed in a population of molecules. This isotope abundance distribution for a peptide can be determined by calculating the atomic composition of that peptide and then applying a combinatorial probability model to determine the proportion of the peptide molecule population that would be expected to comprise different isotope variants. A method, using such a model, to calculate peptide isotope abundance distributions from peptide atomic composition and known natural isotope abundances is described by Gay et al.¹⁴. To determine the average isotope abundance distribution for peptides of a given monoisotopic mass, requires determination of the isotope distribution of a large number of different peptides of that mass. A large number of peptide sequences of a given mass can be generated by randomly creating sequences and calculating their monoisotopic masses and then sorting the sequences into groups with the same mass. This calculated list of peptides of each mass can then be used to determine an average peptide isotope distribution. Altematively, since peptides are generally produced from proteins by enzymatic digestion, a large number of peptides can be generated by calculating the expected peptide sequences that would be produced from public databases of protein sequences, such as SWISS-PROT^{15,16} or the Protein Information Resource^{17,18} by simulated digestion with a given protease, such as trypsin. The predicted fragments can be sorted according to mass and the average isotope distribution of these peptides can be calculated. This latter method is preferred as the public databases reflect natural amino acid abundances. The databases can be searched by organism to provide proteins for a given organism from which peptides can be determined, thus reflecting organism specific amino acid distributions. Similarly, databases of atomic compositions of labelled biomolecules can be readily derived from existing databases, e.g. the atomic compositions of labelled peptides can be determined by substituting the atomic composition of the expected labelled amino acids into the sequences of the unmodified peptides. It should be noted that the predicted range of variation in isotope intensities for an ion of a given mass-to-charge ratio in the database should also be determined as this is important in defining the isotope templates. Similarly, the range of variation in isotope intensities as recorded by the mass spectrometer to be used with this invention can also be taken into account in the calculation of the templates.

The mass of a peptide determines the shape of the isotope distribution. FIGS. 5a and 5b illustrate typical average isotope distributions of peptides derived from a publicly available database and it can be seen that the mass and charge state of the peptide has a dramatic effect on the shape of the distributions. Obviously as the charge state increases the difference in mass-to-charge ratio between isotope variants becomes correspondingly smaller, for the 2+ state the difference in m/z between the first and second isotope peak becomes half an m/z unit, while for the 3+ state the difference between the first and second isotope peak is one third of an m/z unit. Also, as the mass of the peptide increases, there is an increase in the dominance of more massive isotope variants. For the purposes of screening a mass spectrum, it has been found in a TOF mass analyser that charge states of greater than +6 are not usually observed due to limitations in instrument resolution, thus the number of templates that need to be calculated will be determined by instrument capabilities and the amount of computation required can be adjusted accordingly.

The actual templates are determined from the average isotope distributions, by determining the ratios of the intensities of different isotope peak height maxima to the first peak height.

The effect of increasing peptide mass on the ratio between the intensity of the first peak and the intensity of higher isotope species is shown in FIG. 6a. This figure also illustrates another important point, which is that the range of expected isotope intensities should also be determined. The range of variation in isotope intensities is also shown in FIG. 6a. The template for each charge state and mass, thus, actually comprises the expected difference in isotope peak separation and the isotope abundance ratios with the expected deviation of these abundances from the mean that should be allowed for, coupled to the expected differences in mass-to-charge ratio for each isotope peak. A slightly larger deviation than the calculated deviation of isotope intensities should be allowed for to take into account random fluctuations in the actual measurements made. Similarly, the mass accuracy of the instrument must be taken into account in the determination of the location of each isotope peak in relation to each other. The template concept and the allowed tolerances are illustrated graphically in FIG. 6b.

FIG. 3 provides a flow-chart that illustrates how the mass- and charge-dependent templates are applied to a mass spectrum S(x, y). The spectrum S(x, y) comprises a list of ions with mass-to-charge ratio x and intensity y, sorted in order of their measured mass-to-charge ratio. For each ion peak in the spectrum, with a measured mass-to-charge ratio, a series of templates is calculated where the series comprises a template for each different possible charge state of an ion with the measured mass-to-charge ratio; In the case of labelled peptides a template is calculated for each possible labelled species, taking into account different numbers of tags. Where a database is used all the entries in the database that could give rise to an ion with the measured mass-to-charge ratio in a given charge state (and for labelled peptides with a given number of tags) are used to calculate each template, which represents an average isotope abundance distribution for the ions that could give rise to a given peak, with the expected variations in intensity and peak separation as discussed above. The template corresponding to the highest expected charge state is applied to the spectrum first. Ions are selected from the mass spectrum S(x, y) starting from the ion with the lowest recorded mass-to-charge ratio. To compare a given ion with a template, the spectrum S(x, y) is checked to determine whether the next ion has a difference in mass-to-charge ratio that corresponds to the difference for the second isotope peak in the template, within the allowed tolerances. If the next ion in S(x, y) has the appropriate mass-to-charge ratio, the ratio of the intensity of the first peak to the second peak is calculated. If this falls within the tolerated range of the template, the next ion from S(x, y) is tested against the template in the same way, to see if it corresponds to the third isotope peak. Typically, only the ratios of the intensities of the first three isotope peaks need to be checked although more peaks can be used if desired. Thus if the first three ions meet the criteria of the template they are added to a preliminary Hit List (Hₚ). The process is then repeated for the next ion in S(x, y) until all the ions have been checked against the first template. In this way, a spectrum S(x, y) can be rapidly screened for regions that contain ions with predetermined characteristics.

The potential ion families in the Hit List Hₚ are then confirmed by application of a more sophisticated model of isotope distributions, which takes into account the measured deviation in the peak recorded for each ion. This modelling step is more time-consuming, hence the need for the faster template scanning procedure described above. Accurate modelling, however, is important as the fitted model is used to determine key parameters for each fitted peak in the spectrum such as the measured mass-to-charge ratio of the peak and the peak area, which is essential to quantify the amount of the corresponding ion present in a spectrum. Each peak in a TOF spectrum, for example, is assumed to comprise ions of the same atomic composition. Their arrival times at the detector vary according to the energy imparted to the ions, which causes a spread in recorded arrival times. The distribution of ion energies can be approximated by a Gaussian density function. Alternatively, Lorenzian or Voigt functions can be used to model ion peak shapes. Similarly, different instrument configurations will produce ion peaks with characteristic shapes that typically vary with ion energy distribution. The ion energy distribution is a complicated function that arises from the interaction between the method of ionisation and the mechanism of mass analysis. These ion peak shapes can, in most cases, be modelled by estimating parameters for a Gaussian, Lorenzian or Voigt function. Thus, after identifying regions of a spectrum that could correspond to ions of interest with the aforementioned templates, these preliminary identifications are confirmed with a more accurate ion peak shape model. In a preferred embodiment of this invention, a Gaussian model of the isotope distribution is fitted to each peak (identified from the preliminary Hit List Hₚ) in the spectrum S(x, y) and a least squares error is calculated to determine how well the measured data fit the model. Graphs of these accurate models are shown in FIG. 5b. If the error is less than a pre-defined threshold the preliminary hit is accepted. Peaks from Hp that meet the criteria of the more sophisticated modelling are then moved to a second list of confirmed hits H_{c}. The data for the peaks added to H_{c} are also removed from the spectrum S(x, y). The areas of the higher isotope peaks in H_{c} are added to the first isotope, so that H_{c} only records the monoisotopic mass for each peak and the sum of the isotope intensities. The parameters, such as mass-to-charge ratio and peak area that are determined by the fitted models for each peak are recorded with the monoisotopic ions in H_{c}. In addition the charge state, determined by the template or model that the isotope peaks matched, is recorded with the monoisotopic intensity.

Once the template for a given charge state has been tested, the template for the next lowest charge state are applied to the mass spectrum consecutively until the +1 charge state template have been checked. A confirmed ion family identified by a template is added to the confirmed hit list H_{c} and the peaks that correspond to the ion family are removed from the spectrum S(x, y). Once all the templates for a given ion have been tested the next ion in the spectrum is analysed in the same way. The end result of this process is a list of confirmed monoisotopic ions, with known mass-to-charge ratios, charge states and intensities.

In some embodiments of this invention, the spectrum of identified mono-isotopic ion species is analysed to determine whether there are multiple charge states of any molecular species present in the spectrum. A method to do this, which is shown as a flow chart in FIG. 4, starts with a hit list, H_{c}, of confirmed mono-isotopic ion peaks produced by the template matching procedure of the first aspect of this invention. A final mass list, M, is initialised using H_{c}. The final mass list is initialised with the ions from H_{c} which are in charge state +1. The ion data added to M is removed from H_{c}. The method then starts with the ions with the highest detected charge state in H. For each ion in the highest charge state, the expected mass-to-charge ratio of the same ion in the +1 state is calculated. The final mass list is then searched to determine whether an ion corresponding to this +1 charge state is present (within a pre-defined error in the determination of the mass-to-charge ratio of the lower ion mass). If such an ion is found in the final mass list M it is assumed that it corresponds to the same molecular species as the higher charge state. The ion intensity of the higher charge state species is determined and then added to the matching +1 species in M and the higher charge state species is removed from the hit list H. Determination of ion intensity is instrument dependent, in a quadrupole, for example, the intensity is simply the ion count for each gated species, while in a TOF mass analyser, the peak area of each ion must be integrated. If no +1 state is found, the charge state of the unmatched species is changed to the +1 state and the higher state is removed from H, i.e. the high charge state species is replaced with a species with an ion of the same intensity in the +1 state, which is added to M. The process is repeated with list of ions of the next lower charge state from the spectrum down to ions with a +2 charge state. The end result is a final mass list, M, comprising monoisotopic species all in the +1 charge state whose intensities correspond to the sum of the intensities of all the ions that comprise the charge state envelope for that ion. This charge state deconvolution process provides additional information to characterise an ion and in some embodiments, the intensity of each charge state of a given ion will be recorded with the deconvoluted monoisotopic species in the +1 charge state. This charge state envelope data can be used to compare spectra particularly in liquid chromatography analyses where multiple spectra are generated from sample material eluting from a chromatographic separation. The mass-to-charge ratios of higher charge states of a given ion are likely to be measured more accurately in a mass spectrometer as mass accuracy of most instruments is greater for species with lower mass-to-charge ratios. Thus, careful charge state deconvolution can allow for improved determination of the mass-to-charge ratio of the +1 state.

In some embodiments of this invention, the isotope abundance distribution templates are calculated ‘on-the-fly’, i.e. when they are needed. In other embodiments, the templates can be pre-calculated and stored in a form that allows them to be accessed when needed. This is possible, for example, where peptides are analysed and the templates are calculated from a database of peptide sequences since there will only be a fixed number of species in the database that can give rise to an ion with a given mass-to-charge ratio. Thus, templates corresponding to all the expected charge states of every entry in the database of peptides can be calculated in advance.

Processing of Time-of-Flight Data

In order to apply the method provided in the first aspect of this invention to mass spectral data, the data must be in a format that is meaningful for this method. It is necessary for the data to comprise a list of ion intensities with known mass-to-charge ratios. Different types of mass analyser produce raw data in different forms which must be processed to produce the list of ion intensities with their mass-to-charge ratios.

In a time-of-flight mass spectrometer, pulses of ions with a narrow distribution of kinetic energy are caused to enter a field-free drift region. In the drift region of the instrument, ions with different mass-to-charge ratios in each pulse travel with different velocities and therefore arrive at an ion detector positioned at the end of the drift region at different times. The analogue signal generated by the detector in response to arriving ions is immediately digitised by a time-to-digital converter. Measurement of the ion flight-time determines mass-to-charge ratio of each arriving ion. There are a number of different designs for time of flight instruments. The design is determined to some extent by the nature of the ion source. In Matrix Assisted Laser Desorption Ionisation Time-of-Flight (ALDI TOF) mass spectrometry pulses of ions are generated by laser excitation of sample material crystallized on a metal target. These pulses form at one end of the flight tube from which they are accelerated.

In order to acquire a mass spectrum from an electrospray ion source, an orthogonal axis TOF (oaTOF) geometry is used. Pulses of ions, generated in the electrospray ion source, are sampled from a continuous stream by a ‘pusher’ plate. The pusher plate injects ions into the Time-Of-Flight mass analyser by the use of a transient potential difference that accelerates ions from the source into the orthogonally positioned flight tube. The flight times from the pusher plate to the detector are recorded to produce a histogram of the number of ion arrivals against mass-to-charge ratio. This data is recorded digitally using a time-to-digital converter.

In both MALDI-TOF and ESI-oaTOF about 1,000 ion pulses are typically analysed to obtain a complete spectrum during a total time period of about 100 mS. The signals from each pulse are added to the histogram thus generating the raw digitised TOF spectrum.

The second aspect of this invention provides a method to process mass spectral data produced by a Time-Of-Flight mass spectrometer to reduce the data to a list of ions of interest. FIG. 1 shows a flow-chart of the general process provided. The analytical method operates on raw digitised Time-Of-Flight data. There are three general steps in the method to process the raw TOF spectrum. Pre-processing of the spectrum to render the spectrum compatible with the second step, which identifies ions in the spectrum with pre-determined isotope patterns and charge states. The final step of the process identifies ions that are present in the spectrum in multiple charge states and deconvolutes these states to a single +1 charge state. The end product of this analytical process is a spectrum comprising a list of monoisotopic ion intensities in the +1 charge state, where the ions all meet the criteria of the isotope distribution templates applied to the spectrum.

Pre-processing of Time-Of-Flight data is usually performed by software provided by the manufacturer of the instrument, e.g. the MassLynx software provided by Micromass (Manchester, UK) to operate their ESI-TOF and Q-TOF instrumentation. It is, however, sometimes preferable to be able to process the data directly and the general steps necessary to process TOF data to render it compatible with the methods of this invention are shown in FIG. 2. For a review of some of the standard digital signal processing techniques discussed below see, for example, ‘The Scientist and Engineer's Guide to Digital Signal Processing’¹⁹.

Typically the digital signal from the TOF mass analyser is contaminated by low levels of random noise. Preferably, this noise is removed prior to further analysis. Various methods of removing noise are applicable. In general the noise levels are very low compared to the ion signals. The simplest noise elimination method, therefore, is to set a threshold intensity below which the signal will ignored (or removed). However, the noise level for a Time-Of-Flight mass analyser is found to vary as the mass-to-charge ratio increases so it is better to apply a varying threshold for different mass-to-charge ratios. A standard threshold function could be determined for a given instrument relating noise to the mass-to-charge ratio and this could be used to eliminate signals below the threshold level of intensity. A more preferred method, however, would be to make a data-dependant noise-estimation for different mass-to-charge ratios for each spectrum, as this allows random variations between analyses on a particular instrument to be accounted for and it makes the method independent of the instrument used. This can be done by splitting the raw spectrum into bins and estimating the noise in each bin. An interpolation or spline function describing an appropriate curve can then be fitted to the noise estimates for each bin to provide an adaptive threshold that varies over the full mass-to-charge ratio range of the spectrum. Signals below the calculated threshold are then removed from the spectrum.

After the random background noise has been removed the digital signal must be smoothed prior to attempting to find ion peaks in the data. Smoothing can be achieved by various methods. Typically the digital mass spectrum data would be convoluted with a low bandpass filter. A low bandpass filter generally smoothes a digital signal by effectively determining a moving average of the signal. This removes very high frequency signals from the data, that correspond to small random variations in the digitised signal intensities for each ion. The digital signal can be convoluted with a number of different filter kernels that have a smoothing effect, such as a simple square function, which produces a modified spectrum in which a moving average has been applied where there is equal weighting to every point in the moving average. A more preferred filter kernel applies a higher weighting to the central point in the moving average. Appropriate filter kernels include filters derived from a windowed sinc function, Blackman windows and Hamming windows. In a more preferred embodiment, the TOF spectrum is smoothed by convolution with a filter kernel derived from a Gaussian function.

Identification of peaks in a digital signal is essentially the same as for a continuous signal. With a continuous signal the first and second differentials of the signal are calculated; maxima and minima of the signal, i.e. peaks and troughs, are identified where the first differential is zero, while maxima are identified where the second differential is negative. For a discrete signal a Laplacian filter determines appropriate corresponding difference equations that facilitate detection of peaks in the digital signal.

Once a list of peaks has been identified from the TOF data with their corresponding mass-to-charge ratios, the method provided by the first aspect of this invention can be applied to this list of peaks. The end result of this process is a list of confirmed monoisotopic ions, with known mass-to-charge ratios, charge states and intensities.

In the final step in the processing of TOF data, shown in FIG. 1, the spectrum of identified mono-isotopic ion species is analysed to determine whether there are multiple charge states of any molecular species present in the spectrum. A method to do this, which is shown as a flow chart in FIG. 4, starts with a hit list, H_{c}, of confirmed mono-isotopic ion peaks produced by the template matching procedure of the first aspect of this invention. A final mass list, M, is initialised using H_{c}. The final mass list is initialised with the ions from H_{c} which are in charge state +1. The ion data added to M is removed from H_{c}. The method then starts with the ions with the highest detected charge state in H. For each ion in the highest charge state, the expected mass-to-charge ratio of the same ion in the +1 state is calculated. The final mass list is then searched to determine whether an ion corresponding to this +1 charge state is present (within a pre-defined error in the determination of the mass-to-charge ratio of the lower ion mass). If such an ion is found in the final mass list M it is assumed that it corresponds to the same molecular species as the higher charge state. The ion intensity of the higher charge state species is determined by integrating the peak area of the ion from the TOF data. This integrated peak intensity is then added to the matching +1 species in M and the higher charge state species is removed from the hit list H. If no +1 state is found, the charge state of the unmatched species is changed to the +1 state and the higher state is removed from H, i.e. the high charge state species is replaced with a species with an ion of the same intensity in the +1 state, which is added to M. The process is repeated with list of ions of the next lower charge state from the spectrum down to ions with a +2 charge state. The end result is a final mass list, M, comprising monoisotopic species all in the +1 charge state whose intensities correspond to the sum of the intensities of all the ions that comprise the charge state envelope for that ion.

It may be desirable to record the intensities of each charge state of a given molecular ion species during the charge state deconvolution process as this data may be useful for characterising the ion or to reconstruct the original spectrum.

Other Mass Analysers

The methods of this invention are equally applicable to spectra generated on instruments that do not comprise a Time-Of-Flight mass analyser, however the TOF mass analyser is preferred as it has a high mass resolution allowing ions with higher charges (>+4) to be resolved. Quadrupole-based instruments typically have a lower mass resolution and mass accuracy than TOF-based instruments but the raw data can be analysed by the methods of this invention, although higher charge state species are not well resolved on these instruments. An advantage of quadrupole data is that its spectra typically do not require smoothing. De-noising methods would be similar to those described for the TOF. Sector instruments can also have a high mass resolution but tend to be less sensitive than a corresponding TOF mass analyser. Fourier Transform Ion Cyclotron Resonance (FT-ICR) mass spectra can also be analysed using the methods of this invention. These instruments can produce very high resolution data allowing high charge states to be resolved and are also preferred for use with this invention.

Software

In preferred embodiments of this invention, the methods for interpreting mass spectra are provided in the form of computer programs on a computer readable medium to allow a computer to carry out the methods of this invention automatically.

Parallelisation of the Isotope Template Matching Software

As discussed above the methods of this invention can be implemented as programs on a computer readable medium that are performed by a computer processor. An implementation of such algorithms has been completed which runs on single processor computers. This sort of implementation of the algorithm in software is fully functional but is comparatively slow, taking approximately 1 minute/spectrum, to process a typical liquid chromatography analysis of a sample of peptides which may produce several thousand independent TOF spectra. It is therefore desirable to have a means of increasing the speed of the analysis so that the analysis time is not the limiting factor in the throughput of a mass spectrometric analytical system. The template matching procedure treats each ion species as independent entities, even though many charge states of the same source molecule may exist in a spectrum, so this means that the algorithm can be easily applied in parallel on several processors on distinct sub-portions of each spectrum that is to be processed. Equally, a different spectrum can be distributed to each processor. In one embodiment, the software would be loaded onto a LINUX cluster which typically comprises several different computer ‘nodes’ connected over a network, e.g. an Ethernet switch, to a special node computer called the front-end (sometimes ‘nodes’ are referred to as ‘slaves’ and the ‘front-end’ as the ‘master’). The front-end typically comprises a keyboard, monitor and mouse connected to the front-end computer to allow human interfacing with the cluster. The cluster is thus controlled through the front-end. The front-end computer would be responsible for dividing each mass spectrum that is processed into sub-spectra comprising a small range of mass-to-charge. Each sub-spectrum would be sent over the network connection to a different computer which would apply the software of this invention to the data. Once each computer has completed running the algorithm, the results are returned to the master computer over the network to be reassembled into a single spectrum in which all the ions meeting the criteria of the template matching software have been identified over the full mass spectrum. The master computer would then perform any additional processing such as charge state deconvolution, which must be performed on the whole reassembled spectrum.

On a UNIX-based parallel processing system such as a LINUX cluster, the parallelisation can be effected in a simple manner: copies of the software of this invention for processing mass spectra are installed on each node of the cluster. An additional program is installed on the front-end computer. This additional program divides the mass spectrum into sub-spectra, distributes the sub-spectra to the nodes and instructs the nodes to execute the mass spectrum processing software and instructs the nodes to return the data to the front-end. After execution of these first steps the program on the front end waits for the data to be returned and then synthesises the returned data into a single spectrum.

In another embodiment of this aspect of the invention, the software for ion detection can be encoded in a language, such as C, that has support for the publicly available Parallel Virtual Machine software package²⁰. This software package, originally developed at the Oak Ridge National Laboratory (Tennessee, USA) permits a heterogeneous collection of Unix and/or Windows computers linked over a network to be used as a single large parallel computer.

Applications of the Methods of this Invention

While peptides have characteristic isotope abundance distributions, it is often worthwhile to modify the isotope abundance distributions of peptides to allow specific features to be identified. The ICAT method⁵, for example, isolates cysteine containing peptides from biological material as a way of obtaining a small specific sample of peptides from each protein in the mixture. ICAT has demonstrated the utility of the analysis of peptides containing cysteine for the characterisation of a complex peptide mixture. Another way of identifying cysteine containing peptides is to tag the cysteines with a label that gives the peptides a characteristic isotope distribution. A number of labels and tagging procedures have been developed for this purpose^{13, 21-23}. The methods described in these papers all appear to have required manual interpretation of the MS data. According to the fourth aspect, the methods of this invention can potentially offer an automated procedure for the interpretation of the mass spectra of such isotope tagged species. Accordingly, in one embodiment of the fourth aspect of this invention, a method for identifying cysteine containing peptides is provided comprising the steps of:
1. tagging a mixture of peptides with a cysteine reactive tag with a characteristic isotope distribution, e.g. dichlorobenzyliodoacetamide²¹.
2. calculating templates for cysteine containing peptides derived from a database for the organism to be analysed, where there is a template for each expected combination of charge state, mass range and number of tags present in the peptides.
3. applying the tag-, mass- and charge-dependent isotope distribution templates consecutively, to mass spectra containing labelled peptide ions, starting with the template for the highest expected number of tags and charge state for each ion in the spectrum, to find regions of the mass spectrum that match the isotope templates.
4. fitting expected isotope distributions to the peptide ions identified by the template matching procedure to confirm the preliminary identifications, thereby identifying the charge state of the peptide and the number of tags reacted with the peptide.

Similarly, it is possible to label amino groups in proteins, either epsilon amino groups of lysine and/or alpha amino groups at the N-termini of peptides. WO 02/099436 and WO 02/099124 disclose tags for the selective labelling of epsilon amino groups, such as pyridyl propenyl sulphone. These reagents comprise sulphur atoms and impart a characteristic isotope abundance distribution to the labelled peptides. In addition GB 0306756.8 discloses amine reactive tags which can be used to label alpha amino and epsilon amino groups in peptides simultaneously while also imparting a characteristic isotope abundance distribution to the labelled peptides. Thus a further embodiment according to the fourth aspect of this invention, a method for identifying peptides by labelling amino groups is provided comprising the steps of:
1. tagging a mixture of peptides with an amino reactive tag with a characteristic isotope distribution, e.g. pyridyl propenyl sulphone.
2. calculating templates for peptides containing labelled amino groups derived from a database for the organism to be analysed, where there is a template for each expected combination of charge state, mass range and number of tags present in the peptides.
3. applying the tag-, mass- and charge-dependent isotope distribution templates consecutively to mass spectra of labelled peptide ions, starting with the template for the highest expected number of tags and charge state for each ion in the spectrum, to find regions of the mass spectrum that match the isotope templates.
4. fitting expected isotope distributions to the peptide ions identified by the template matching procedure to confirm the preliminary identifications, thereby identifying the charge state of the peptide and the number of tags reacted with the peptide.

### REFERENCES

(1) Mann, M.; Wilm, M. Anal Chem 1994, 66, 4390-4399.
(2) Washburn, M. P.; Wolters, D.; Yates, J. R. Nat Biotechnol 2001, 19, 242-247.
(3) Washburn, M. P.; Ulaszek, R.; Deciu, C.; Schieltz, D. M.; Yates, J. R., 3rd Anal Chem 2002, 74, 1650-1657.
(4) Gaskell, S. Journal of Mass Spectrometry 1997, 32, 677-688.
(5) Gygi, S. P.; Rist, B.; Gerber, S. A.; Turecek, F.; Gelb, M. H.; Aebersold, R. Nat Biotechnol 1999, 17, 994-999.
(6) Karas, M.; Hillenkamp, F. Anal Chem 1988, 60, 2299-2301.
(7) Hillenkamp, F.; Karas, M. Methods Enzymol 1990, 193, 280-295.
(8) Hillenkamp, F.; Karas, M.; Beavis, R. C.; Chait, B. T. Anal Chem 1991, 63, 1193A-1203A.
(9) Pappin, D. J. C.; Höjrup, P.; A. J., B. Curr Biol 1993, 3, 372-332.
(10) Mann, M.; Hojrup, P.; Roepstorff; P. Biol Mass Spectrom 1993, 22, 338-345.
(11) Yates, J. R., 3rd; Speicher, S.; Griffin, P. R.; Hunkapiller, T. Anal Biochem 1993, 214, 397-408.
(12) Karas, M.; Gluckmann, M.; Schafer, J. J Mass Spectrom 2000, 35, 1-12.
(13) Sechi, S.; Chait, B. T. Anal Chem 1998, 70, 5150-5158.
(14) Gay, S.; Binz, P. A.; Hochstrasser, D. F.; Appel, R. D. Electrophoresis 1999, 20, 3527-3534.
(15) Bairoch, A.; Apweiler, R. Nucleic Acids Res 2000, 28, 45-48.
(16) Gasteiger, E.; Jung, E.; Bairoch, A. Curr Issues Mol Biol 2001, 3, 47-55.
(17) Barker, W. C.; Garavelli, J. S.; Huang, H.; McGarvey, P. B.; Orcutt, B. C.; Srinivasarao, G. Y.; Xiao, C.; Yeh, L. S.; Ledley, R. S.; Janda, J. F.; Pfeiffer, F.; Mewes, H. W.; Tsugita, A.; Wu, C. Nucleic Acids Res 2000, 28, 41-44.
(18) Barker, W. C.; Garavelli, J. S.; Hou, Z.; Huang, H.; Ledley, R. S.; McGarvey, P. B.; Mewes, H. W.; Orcutt, B. C.; Pfeiffer, F.; Tsugita, A.; Vinayaka, C. R.; Xiao, C.; Yeh, L. S.; Wu, C. Nucleic Acids Res 2001, 29, 29-32.
(19) Smith, S. W. The Scientist and Engineer's Guide to Digital Signal Processing: California Technical Publishing, 1997.
(20) Geist, A.; Beguelin, A.; Dongarra, J.; Jiang, W.; Manchek, R.; Sunderam, V. PVM: Parallel Virtual Machine A Users' Guide and Tutorial for Networked Parallel Computing; MIT Press, 1994.
(21) Goodlett, D. R.; Bruce, J. E.; Anderson, G. A.; Rist, B.; Pasa-Tolic, L.; Fiehn, O.; Smith, R. D.; Aebersold, R. Anal Chem 2000, 72, 1112-1118.
(22) Sechi, S. Rapid Commun Mass Spectrom 2002, 16, 1416-1424.
(23) Adamczyk, M.; Gebler, J. C.; Wu, J. Rapid Commun Mass Spectrom 1999, 13, 1813-1817.

1. A method for processing data from a mass spectrum generated from a sample, which method comprises:
(a) selecting a first peak in the mass spectrum;
(b) selecting a first monoisotopic reference ion having a first charge state, which first reference ion could give rise to the first peak;
(c) for one or more other isotopic forms of the first reference ion determining one or more further expected peaks in the mass spectrum;
(d) comparing one or more of the determined further expected peaks with the mass spectrum to determine whether there are one or more peaks present in the spectrum that match the one or more determined further expected peaks;
(e) if one or more of the determined further expected peaks match one or more of the peaks in the mass spectrum, designating the first peak as a data peak, and optionally designating the one or more peaks present in the spectrum that match the one or more determined further expected peaks as data peaks;
(f) if the determined further expected peaks do not match peaks in the mass spectrum, repeating steps (b) to (e) with one or more further reference ions in one or more further charge states;
(g) optionally if the first peak cannot be designated as a data peak for a reference ion in the first charge state, or for a further reference ion in the further charge states, designating the first peak as a non-data peak;
(h) optionally repeating steps (a)-(g) for one or more further peaks in the mass spectrum.

2. A method for processing data from a mass spectrum according to claim 1, wherein the first charge state is the highest common ion charge state that can be resolved in the mass spectrometer-type from which the mass spectrum is produced.

3. A method according to claim 2, wherein in step (f) each repetition is carried out on the next lowest charge state, until the lowest charge state that can be resolved in the mass spectrometer-type from which the mass spectrum is produced is reached.

4. A method according to claim 2, wherein the charge state is positive or negative.

5. A method according to claim 1, wherein one or more of the designated data peaks in the mass spectrum are modelled using a Gaussian function, a Lorenzian function and/or a Voigt function.

6. A method according to claim 5, further comprising determining the centroid of one or more of the modelled peaks, to refine the mass to charge ratio of the one or more peaks.

7. A method according to claim 1, wherein in step (b) a plurality of reference ions are selected which could contribute to the first peak, and in step (c) for other isotopic forms of each of the plurality of reference ions, one or more further expected peaks in the mass spectrum are determined for each of the plurality of reference ions.

8. A method according to claim 7, wherein the intensities of the further expected peaks for each of the plurality of reference ions are averaged, based upon the relative abundance of each of the plurality of reference ions.

9. A method according to claim 1, wherein the further expected peaks in the mass spectrum are determined for the reference ion using the atomic composition to determine the expected isotopic abundance distribution for the reference ion.

10. A method according to claim 1, wherein the further expected peaks in the mass spectrum are determined for the reference ion using a pre-calculated template for that reference ion.

11. A method according to claim 1, wherein the method further comprises reducing the data peaks for each isotope of one or more reference ions, to peaks representative of a single monoisotopic ion for that reference ion.

12. A method according to claim 1, wherein, for each reference ion, the intensity of the peaks representative of a single monoisotopic ion is calculated as the sum of the intensities of corresponding peaks from each individual isotope.

13. A method according to claim 1, wherein if a plurality of charge states is present in the spectrum for one or more reference ions, the method further comprises reducing the data peaks for each reference ion to peaks representative of a single charge state.

14. A method according to claim 11, wherein, for each reference ion, the intensity of the peaks representative of a single charge state is calculated as the sum of the intensities of corresponding peaks from each individual charge state.

15. A method according to claim 1, wherein the mass spectrum is generated using electrospray ionisation or MALDI.

16. A method according to claim 1, wherein the sample comprises a protein, a polypeptide, a peptide and/or an amino acid.

17. A method according to claim 1, wherein the sample is produced using a chromatographic separation technique.

18. A method according to claim 1, wherein the determined further peaks are calculated using a computer program.

19. A method according to claim 1, wherein the matching of the calculated further peaks with the mass spectrum is performed using a computer program.

20. A method of interpreting a mass spectrum generated from a sample, which method comprises:
(a) processing data from the mass spectrum according to a method as defined in claim 1; and
(b) interpreting the spectrum on the basis of the data peaks only.

21. A method for performing a MudPIT procedure, comprising a method of interpreting a mass spectrum as defined in claim 20.

22. A method for performing an ICAT procedure, comprising a method of interpreting a mass spectrum as defined in claim 20.

23. A computer program for processing data from a mass spectrum, which computer program is arranged to perform the steps of:
(a) selecting a first monoisotopic reference ion having a first charge state, which first reference ion could give rise to a first peak in the mass spectrum;
(b) for one or more other isotopic forms of the first reference ion, determining one or more further expected peaks in the mass spectrum;
(c) comparing one or more of the determined further expected peaks with the mass spectrum to determine whether there are one or more peaks present in the spectrum that match the one or more determined further expected peaks;
(d) if one or more of the determined further expected peaks match one or more of the peaks in the mass spectrum, designating the first peak as a data peak, and optionally designating the one or more peaks present in the spectrum that match the one or more determined further expected peaks as data peaks.

24. The computer program as claimed in claim 23, arranged to perform the further steps of:
(e) if the determined further expected peaks do not match peaks in the mass spectrum, repeating steps (a)-(d) with one or more further reference ions in one or more further charge states;
(f) optionally if the first peak cannot be designated as a data peak for a reference ion in the first charge state, or for a further reference ion in the further charge states, designating the first peak as a non-data peak;
(g) optionally repeating steps (a)-(f) for one or more further peaks in the mass spectrum.

25. The computer program of claims 23 arranged to perform the step of:
for one or more other isotopic forms of the first reference ion, determining one or more further expected peaks in the mass spectrum using a database of information, the information including mass-to-charge ratios for a plurality of ions in a plurality of charge states.

26. The computer program according to claim 23, which program is arranged to run on multiple computers in parallel.
